(19) United States
(12) Patent Application Publication
(10) Pub. No.: US 2011/0271482 A1
(43) Pub. Date: Nov. 10, 2011

(54) FORWARD MOVEMENT MECHANISM OF MOVABLE BODY

(75) Inventor: Mikio Nezu, Kanagawa (JP)

(73) Assignee: NIFCO INC., Yokohama-shi (JP)

(21) Appl. No.: 12/998,546

(22) PCT Filed: Mar. 10, 2009
(86) PCT No.: PCT/JP2009/054522

§ 371 Date: Jul. 25, 2011

(30) Foreign Application Priority Data
Nov. 4, 2008 (JP) 2008-283226

(51) Int. Cl. E05F 3/00

(52) U.S. Cl. 16/49

(57) ABSTRACT

A forward-moving mechanism of a movable body is provided with a receiving member placed movably inside a main body placed in a recessed area provided on either one of a movable body or a stationary body supporting the movable body to be capable of reciprocal movement, and linked to an assisting device for enabling the movable body to move forward up to a prescribed position; and a contact body provided on the other of the movable body and the stationary body contacting with the receiving member and moving inside the main body in the process of forward movement of the movable body. An area for movement of the receiving member in the main body includes a wall part for guiding the movement of the receiving member, and a device for preventing deformation of the wall part is provided adjacent to the wall part.

### TECHNOLOGICAL FIELD

This invention relates to an improvement of a forward-moving mechanism that functions to apply a damping force to a movable body that is moved forward toward a prescribed position during a period from mid-course of the forward movement up to the prescribed position, or to assist the forward movement, or both to apply such damping force and to assist the forward movement.

### BACKGROUND ART

Patent document 1 gives an example of a mechanism for enabling a movable body, which is arranged such that an upper part thereof is placed inside a rail-form body, to move forward automatically up to a stop position after the movable body was moved forward up to a start position of automatic movement.

Such mechanism comprises: a striker body provided inside a rail-form body; a catcher placed movably to follow the direction of movement of the movable body inside a recessed area being formed on an upper part of the movable body and continuing for a distance following this direction of movement; and urging means to urge the catcher. The catcher comprises: a catcher stopper provided to be capable of moving inward and outward on a catcher main body; a gripper body for gripping the striker body provided to be capable of moving forward and backward and receiving the striker body from the front in a non-gripping state; and an urging body to urge these. The gripper body is in the non-gripping state in an advanced position when the catcher stopper is projected from the catcher main body by the urging body, and the catcher stopper is withdrawn into the catcher main body when the gripper body is in the gripping state in a retracted position. A latch hole to latch the catcher stopper during projection is formed in the recessed area, and force is accumulated in the urging means in a reference position of the catcher when the catcher stopper is latched in the latch hole. Also, the striker body enters into the gripper body of the catcher in the reference position when the movable body was moved forward up to the start position of automatic movement. When this entry is accomplished, the gripper body, being pushed by the striker body, moves to the retracted position and the striker body is caught on the catcher by the gripper body. At the same time, the catcher stopper slips out from the latch hole and the catcher moves relatively inside the recessed area by urging of the urging means, whereby the movable body is moved forward forcibly up to the stop position.

Also, in such mechanism, the state of gripping of the striker body by the catcher is maintained by pressing against the gripper body from outside by left and right walls of a case housing this catcher (see paragraph 0049 of patent document 1). Therefore, the state of gripping of the striker body by the catcher can no longer be maintained if deformation widening the space between the left and right walls of such case occurs. Also, conversely, smooth movement of the catcher will be impeded if deformation narrowing the space between the left and right walls of the case occurs. Typically, in the case when a sliding door as an example of a movable body, to which the case constituting such forward-moving mechanism is attached, is made of a woody material, it can be imagined that contraction or other deformation may be brought about on the side of the sliding door by effects of temperature and humidity, whereby a change may be brought about in the space between the left and right walls of the case.
Patent document 1: Japanese Unexamined Patent Publication No. 2007-309088

### SUMMARY OF INVENTION

### Object of the Invention

The main problem to be solved by this invention is to ensure that the movement of the receiving member (comparable to the catcher in patent document 1) is always smooth and the caught state of the contact body (comparable to the striker body in patent document 1) is always stable in this kind of forward-moving mechanism of a movable body.

### Method to Solve the Problem

In order to solve the aforementioned problem, from a first aspect of this invention, a forward-moving mechanism of a movable body comprises: a receiving member placed to be capable of movement inside a main body placed in a recessed area provided on either one of a movable body or a stationary body supporting the movable body to be capable of reciprocal movement, and linked to damping means for applying a damping force to forward movement of the movable body toward a prescribed position, assisting means for enabling the movable body to move forward up to the prescribed position, or the damping means and the assisting means; and

a contact body provided on the other of the movable body and the stationary body, to be brought into contact with the receiving member and be moved inside the main body in the process of forward movement of the movable body;

wherein at least an area for movement of the receiving member in the main body is open on the open side of the recessed area, and includes a wall part for guiding the movement of the receiving member; and

means for preventing deformation of the wall part is provided adjacent to the wall part, or inside the wall part.

Also, in order to solve the aforementioned problem, from a second aspect of this invention, a forward-moving mechanism of a movable body comprises: a receiving member placed to be capable of movement inside a main body placed in a recessed area provided on either one of a movable body or a stationary body supporting the movable body to be capable of reciprocal movement, and linked to damping means for applying a damping force to forward movement of the movable body toward a prescribed position, assisting means for enabling the movable body to move forward up to the prescribed position, or the damping means and the assisting means; and

a contact body, provided on the other of the movable body and the stationary body, to be brought into contact with the receiving member and be moved inside the main body in the process of forward movement of the movable body;

wherein at least an area for movement of the receiving member in the main body is open on the open side of the recessed area, and includes a wall part for guiding the movement of the receiving member; and

the wall part is constituted by a material having higher rigidity than a constituent material of another part of the main body.

The movement of the receiving member for receiving such contact body after contacting with the contact body is guided by the wall part of such main body. Here, the movement of the receiving member would be impeded if the wall part of the main body were to be deformed for some reason. Because deformation of at least the wall part in the area for movement of the receiving member in the main body is prevented, the movement of the receiving member can always be accomplished smoothly, and the forward movement of the movable body toward the prescribed position can be made smooth.

### Effect of the Invention

In this invention, deformation of the wall part for guiding the movement of the receiving member in the place for movement of the receiving member in the main body can be prevented. Therefore, the movement of the receiving member can always be made smooth, and the caught state of the contact body can always be ensured to be stable.

### BRIEF DESCRIPTION OF THE DRAWING

FIG. 1 is a cross-sectional view of a structural diagram of main parts from a side showing the state of use of the forward-moving mechanism according to one of the embodiment of the present invention;

FIG. 2 is an enlarged cross-sectional view of the same structural diagram of main parts from a side;

FIG. 3 is a plan view of the same structural diagram;

FIG. 4 is an enlarged cross-sectional view of the structural diagram of the same main parts from the side;

FIG. 5 is a cross-sectional view of the structural diagram of the main parts from the side showing the state of use of the forward-moving mechanism;

FIG. 6 is an enlarged side view of the same structural diagram;

FIG. 7 is a plan view of the same structural diagram;

FIG. 8 is a perspective exploded view of the structural diagram according to the embodiment above;

FIG. 9 is an exploded cross-sectional view of the same structural diagram;

FIG. 10 is a side view of the structural diagram of the main body according to the embodiment;

FIG. 11 is a perspective view of the structural diagram of the means for preventing deformation according to the embodiment above;

FIG. 12 is a cross-sectional view of the main parts taken along the line A-A in FIG. 10;

FIG. 13 is a perspective view of the structural diagram of the means for preventing deformation according to a first modified example;

FIG. 14 is a perspective view of the structural diagram of the means for preventing deformation according to a second modified example;

FIG. 15 is a side view of the structural diagram of the main body showing the area where the means for preventing deformation, and the like, is provided;

FIG. 16 is a perspective view of the structural diagram of means for preventing deformation according to a third modified example.

### EMBODIMENTS OF THE INVENTION

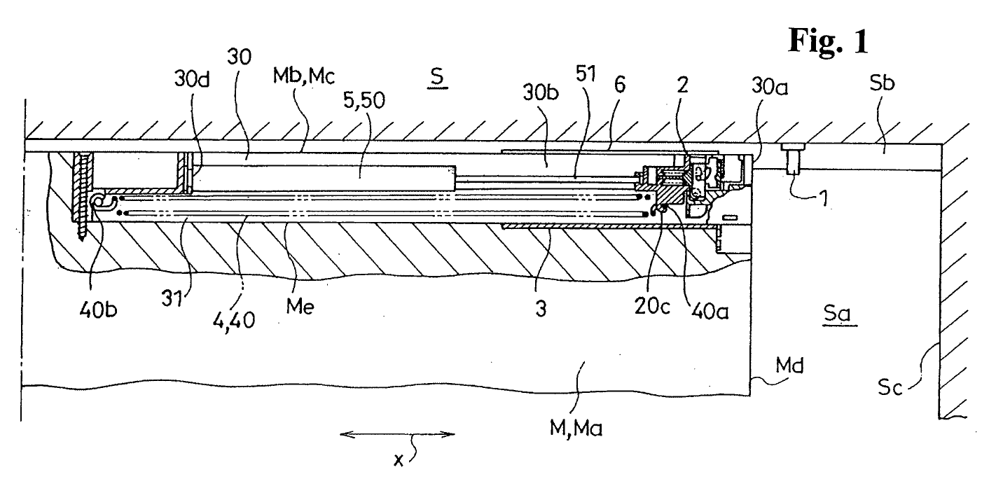

Embodiments of this invention are described below based on FIGS. 1 to 16.

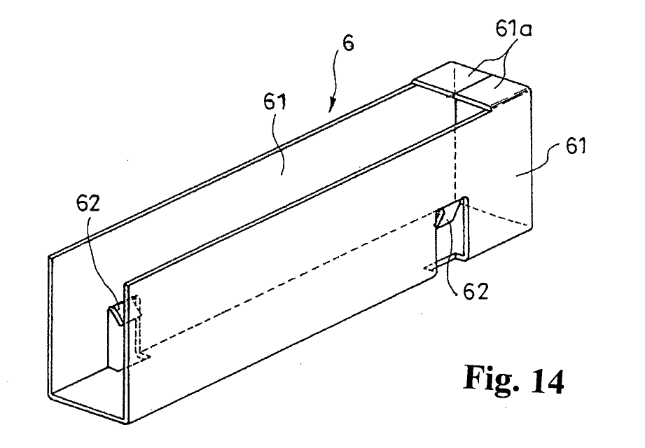

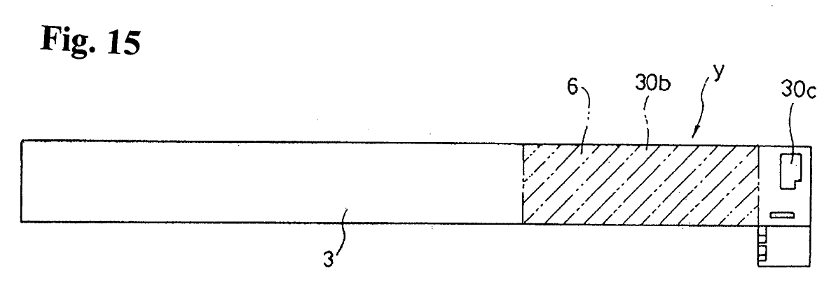

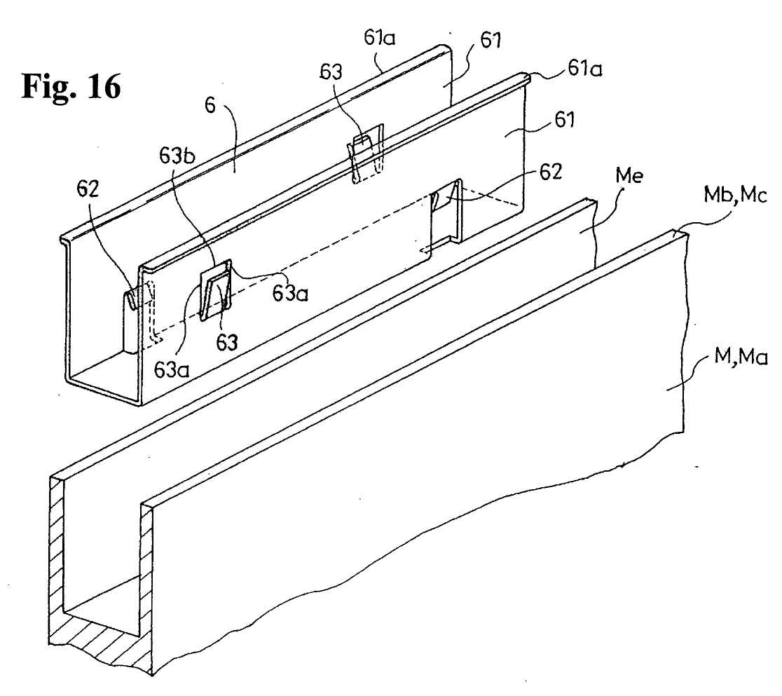

Here, FIGS. 1 to 12 illustrate one example of the forward-moving mechanism according to an embodiment, FIG. 13 illustrates a first modified example of a means for preventing deformation 6 therein, FIG. 14 illustrates a second modified example, FIG. 16 illustrates a third modified example, and FIG. 15 illustrates a range for placement in the case when providing the means for preventing deformation 6, and the like, in a wall part 30b of a main body 3.

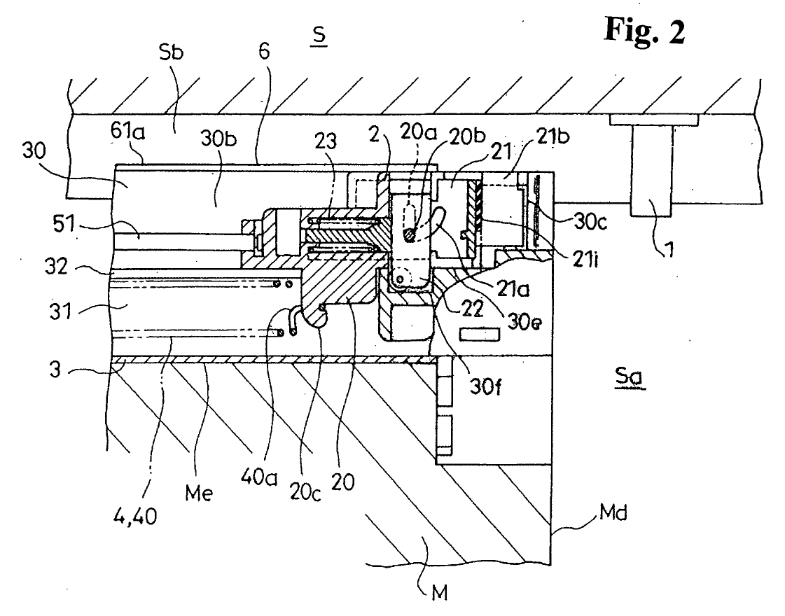

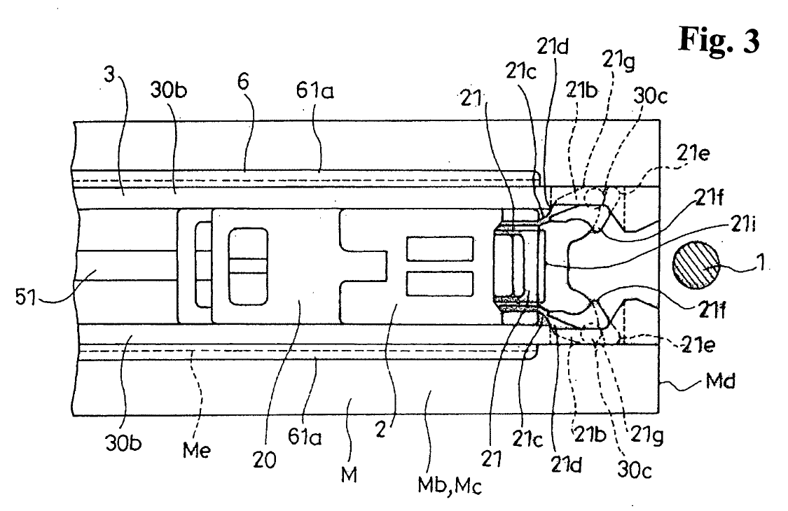

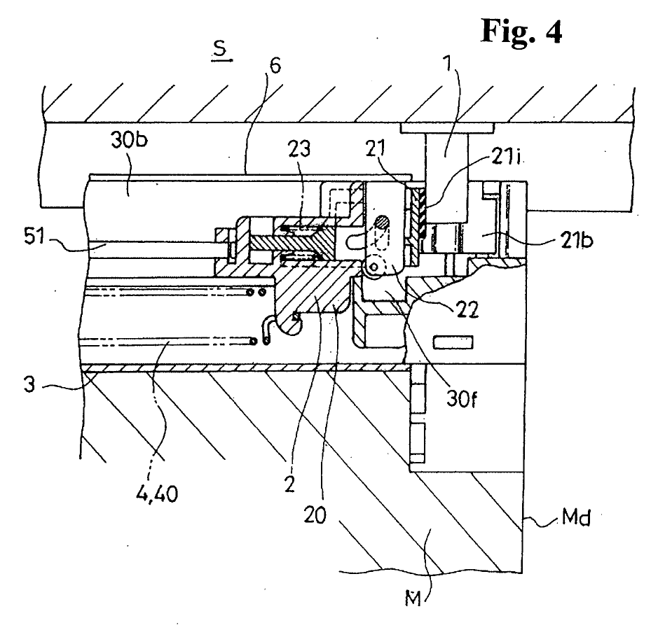

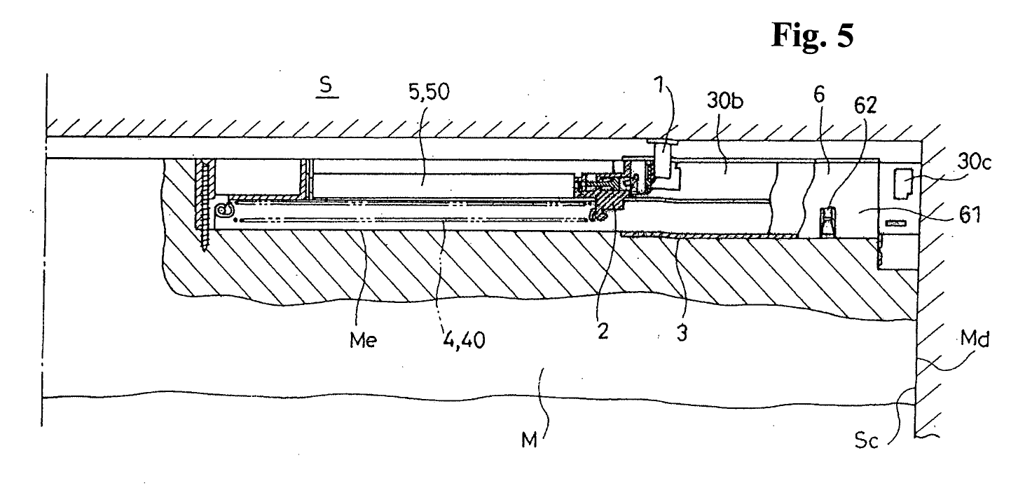

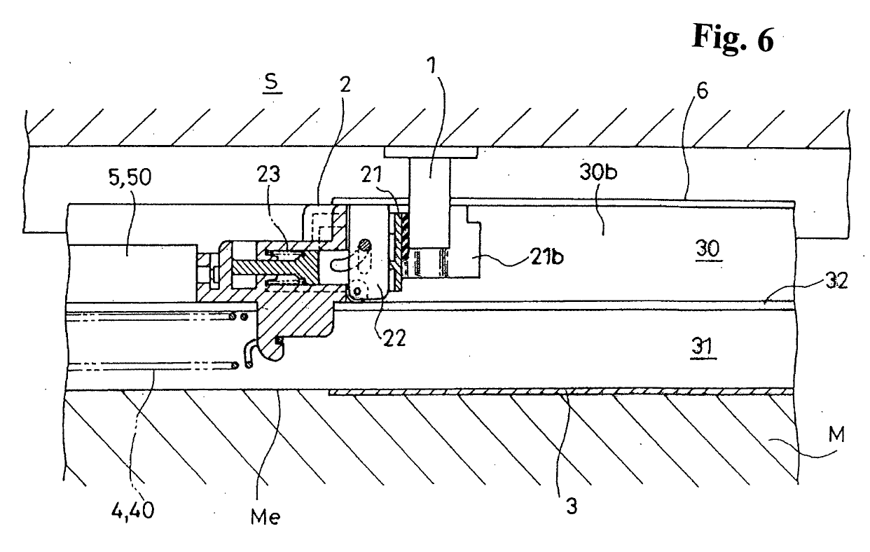

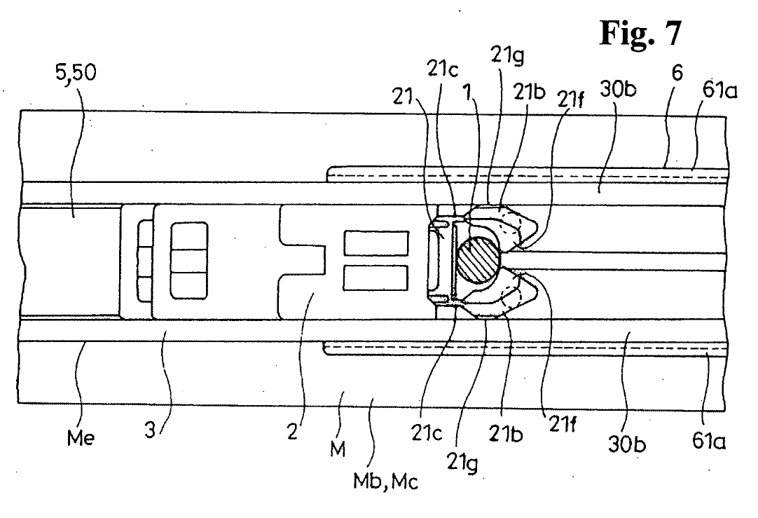

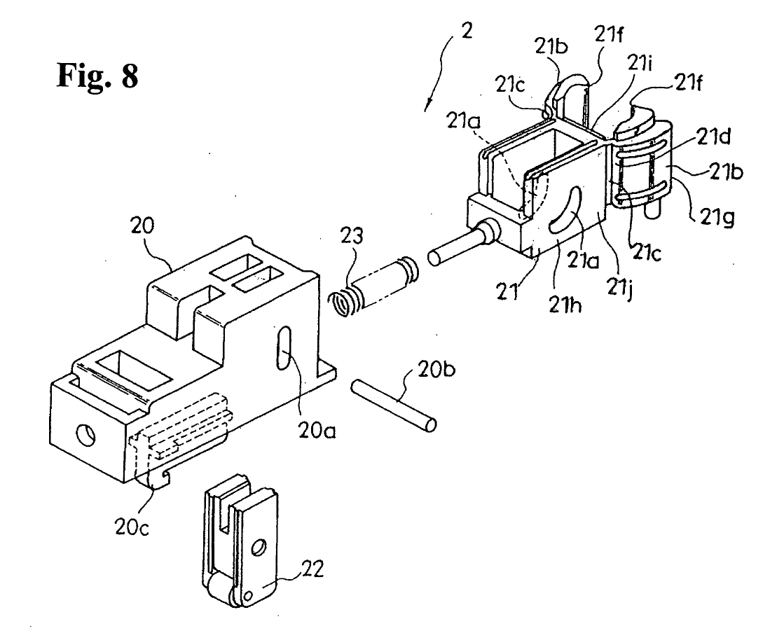

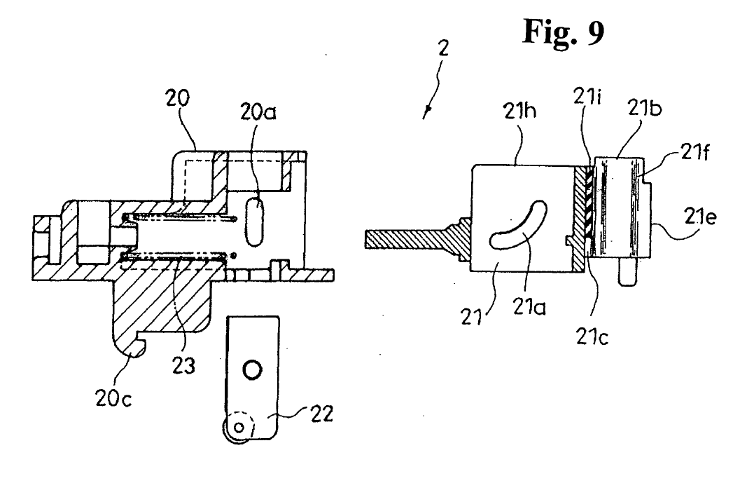

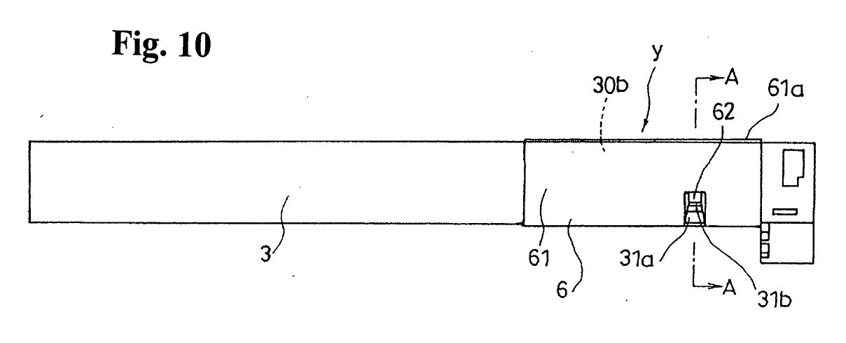

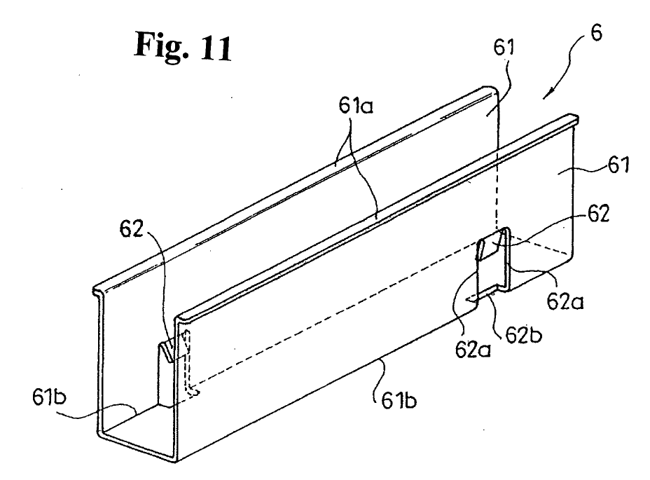

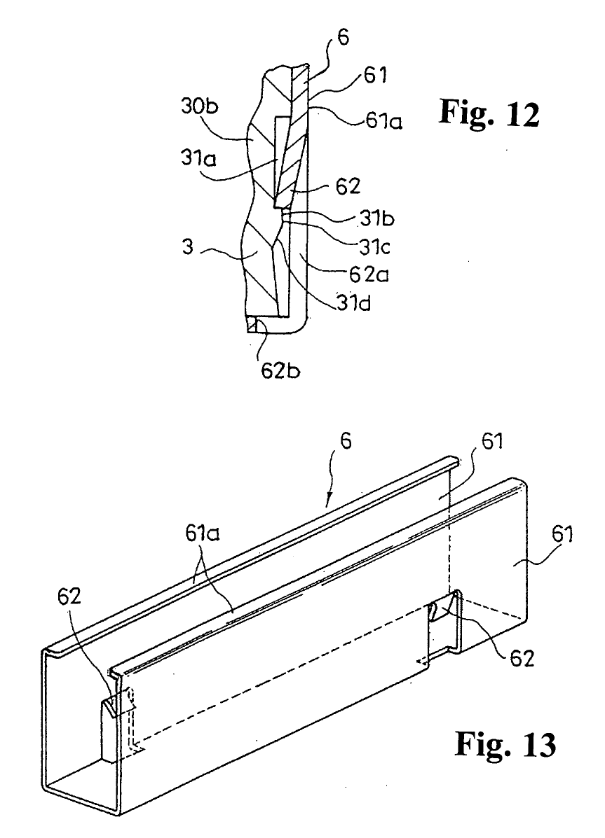

Regarding FIGS. 1 to 12, specifically, FIGS. 1 to 3 illustrate a state before a receiving member 2 provided on the side of a movable body M is brought into contact with a contact body 1, cutting a part of the movable body M and the forward-moving mechanism to open and viewing from the side facing one face of a sliding door Ma as the movable body M (FIG. 1), enlarging the main parts in FIG. 1 (FIG. 2), and viewing the main parts in FIG. 1 from the plane surface (FIG. 3). Also, FIG. 4 illustrates a state immediately after the movable body M was operated to move forward toward a prescribed position from the state in FIG. 1 and the receiving member 2 provided on the side of the movable body M was brought into contact with the contact body 1. Also, FIGS. 5 to 7 illustrate a state in which the receiving member 2 was relatively moved to the limit inside a main body 3 in a state having caught the contact body 1 and the forward movement of the movable body M toward the prescribed position ended, cutting a part of the forward-moving mechanism of the movable body M to open and viewing from the side facing the sliding door Ma as the movable body M (FIG. 5), enlarging the main parts in FIG. 5 (FIG. 6), and viewing the main parts in FIG. 5 from the plane surface (FIG. 7). Also, FIGS. 8 and 9 illustrate each member constituting the receiving member 2 in a disassembled state. Also, FIG. 10 illustrates the main body 3 combined with the means for preventing deformation 6, FIG. 11 illustrates such means for preventing deformation 6, and FIG. 12 illustrates cross-sectional view of a latch area between such means for preventing deformation 6 and main body 3.

The forward-moving mechanism of a movable body M according to this embodiment is to apply a damping force on the movable body M, which is moved forward toward a prescribed position, during a period from mid-course of the forward movement up to the prescribed position, or to assist the forward movement, or both to apply such damping force and to assist.

Such movable body M is supported to be capable of reciprocal movement on a stationary body S, and examples include a sliding door, hanging door, and folding door, but the movable body M is not limited to these, provided that it is supported to be capable of reciprocal movement on the stationary body S. In the illustrated example, an example in which the forward-moving mechanism is provided on a sliding door Ma is illustrated. The sliding door Ma as the movable body M is combined onto the stationary body S, with an upper end part Mb of the sliding door Ma being placed in a rail part Sb provided on the stationary body S, which is provided with an open part Sa that is closed to be capable of being opened by the sliding door Ma, so that the sliding door Ma performs forward movement and return movement following the rail part Sb.

In the illustrated example, the sliding door Ma as the movable body M closes such open part Sa at a prescribed position where a front end Md being at the front when moving forward is brought into collision with a doorstop part Sc of the open part Sa (FIG. 5). Also, when the sliding door Ma as the movable body M is operated to move forward toward the prescribed position from the state in which such open part Sa is not closed (FIG. 1), a contact body 1 contacts with a receiving member 2 constituting the forward moving mechanism (FIG. 4) in the process of this forward movement, so that the sliding door Ma becomes subject to the operation of the forward-moving mechanism up to such prescribed position. In the illustrated example, the contact body 1 is provided on the side of the rail part Sb toward the doorstop part Sc with a space being opened between the contact body 1 and the doorstop part Sc.

In the illustrated example, the contact body 1 is formed as a shaft-form body that hangs downward inside the trough-form rail part Sb with an upper end thereof being fixed to the trough bottom of the rail part Sb. Meanwhile, the receiving member 2 is provided inside a main body 3, which is placed in a recessed area Me formed on the sliding door Ma facing downward from an upper end surface Mc of the sliding door Ma as the movable body M. Such recessed area Me has a trough-form that continues following the direction of sliding of the sliding door Ma and is opened forward at the front end of the sliding door Ma. In the illustrated example, the contact body 1 enters inside the recessed area Me from the side of the front end Md of the sliding door Ma at mid-course of forward movement of the sliding door Ma so as to be brought into contact with the receiving member 2 inside the main body 3 received inside the recessed area Me. Also, sliding door Ma becomes subject to the operation of the forward-moving mechanism up to the prescribed position by this contact.

In the illustrated example, the receiving member 2 is placed to be capable of moving inside the main body 3 following the direction x of movement of the sliding door Ma, and is forcibly moved toward the direction moving away from the front end Md of the sliding door Ma by the urging force of a spring 40 constituting urging means 4. Also, the damping force of damping means 5 is applied to the movement of the receiving member 2 toward the direction moving away from the front end Md of the sliding door Ma.

In the illustrated example, first, until being brought into contact with the contact body 1, the receiving member 2 is first held against the urging of the spring 40 and waits toward the side of the front end Md of the sliding door Ma inside the main body 3 (FIGS. 1 to 3/the position of the receiving member 2 at this time is hereinafter referred to as the “standby position”), and second, when the receiving member 2 is brought into contact with the contact body 1, this hold is released and the contact body 1 is caught instead, so that the receiving member 2 is forcibly moved relatively toward the direction moving away from the front end Md of the sliding door Ma by the urging of such spring 40 (FIG. 4, and subsequently FIGS. 5 to 7). By this, in the illustrated example, when the sliding door Ma as the movable body M is operated to move forward, the forward movement of the sliding door Ma, forward from the position where the contact body 1 contacts with the receiving member 2, is assisted by the receiving member 2, which operates as previously described, so that the sliding door Ma is moved automatically up to the prescribed position where the front end Md is brought into collision with the doorstop part Sc. Also, the damping force of the damping means 5 is applied to the automatic movement of such sliding door Ma, so that the movement is gentle and the sliding door Ma does not produce a loud noise or return to the direction of opening by the reaction force when colliding with the doorstop part Sc.

When the sliding door Ma as the movable body M is operated to move in return after thus having been moved forward up to the prescribed position, the receiving member 2 having caught the contact body 1 is moved relatively toward the side of the front end Md of the sliding door Ma inside the main body 3, while opposing the urging of the spring 40, that is, while accumulating force in the spring 40, and upon reaching the standby position, the receiving member 2 is again held in the main body 3 so as to release the contact body 1. Also the return movement of the sliding door Ma up to the desired position is allowed by this release.

Such forward movement of the movable body M can be assisted from mid-course thereof even when the contact body 1 is attached on the side of the sliding door Ma as the movable body M and the main body 3 containing the receiving member 2 is provided on the side of the stationary body S, being otherwise to the illustrated example. Also, in the illustrated example, such forward-moving mechanism acts on the sliding door Ma as the movable body M when the sliding door Ma is closed, but the forward-moving mechanism can also be used so as to act on the sliding door Ma when such sliding door Ma is opened.

Specifically, the main body 3 assumes a long and slender case form having a width and a length to fit inside the recessed area Me. The main body 3 is divided into an upper chamber 30 and a lower chamber 31. The upper chamber 30 is opened upward across the length direction of the main body 3, and is opened forward at a front end 30a positioned on the side of the front end Md of the sliding door Ma. The receiving member 2 moves inside this upper chamber 30, and this upper chamber 30 is provided with a pair of wall parts 30b, 30b following the length direction of the main body 3, so that the movement of the receiving member 2 is guided by these wall parts 30b. Also, the lower chamber 31 is connected through to the upper chamber 30 by a slit 32 across the length direction of the main body 3.

The receiving member 2 comprises: a base 20; a slider 21 combined in the base 20 to be capable of sliding movement forward and backward; a stopper 22 combined on the case 20 to be capable of sliding movement upward and downward; and a spring 23 for regularly urging the slider 21 toward the direction of projecting from the base 20 toward the side of the front end Md of the sliding door Ma, that is, forward. Also, the stopper 22 and the slider 21 are linked by passing a pin 20b through a vertical guide groove 20a formed on the base 20 and through a cam groove 21a formed on the slider 21. The stopper 22 projects upward from the lower part of the base 20 in the state in which the slider 21 was advanced to the limit by the urging of the spring 23, and the stopper is withdrawn into the base 20 when the slider 21 is retracted in opposition to the urging of the spring 23.

Also, a gripping piece 21b for catching the contact body 1 is provided respectively on the left and right on the front part of the slider 21. The receiving member 2 is thereby provided with a slider 21 as a catcher for the contact body 1. One of such pair of gripping pieces 21b, 21b has a projecting part 21f that projects forward and projects inward between a rear end 21d and a front end 21e, being integrally joined at the rear end 21d by a thin hinge part 21c on a corner part where a front end face 21i of a main body part 21h of the slider 21 and a right side face 21j meet. Also, the other of such pair of gripping pieces 21b, 21b has a projecting part 21f that projects forward and projects inward between a rear end 21d and a front end 21e, being integrally joined at the rear end 21d by a thin elastic hinge part 21c on a corner part where the front end face 21i of the main body part 21h of the slider 21 and a left side face 21j meet. Also, in the illustrated example, such pair of gripping pieces 21b, 21b, in the standby position, is positioned by the elasticity of the elastic hinge part 21c so that the pitch with the other gripping piece 21b is widened while going toward the front end 21e, so that a back part opposite the projecting part 21f is placed in a window hole 30c formed on the wall part 30b on the side of the front end 30a of the upper chamber 30 of the main body 3 (FIG. 3). Also, in the standby position, a space is formed for passing the contact body 1 between the projecting parts 21f of the pair of gripping pieces 21b, 21b (FIG. 3). Also, in the standby position, the stopper 22 enters into a recessed part 30f formed on a bottom part 30e of the upper chamber 30 (FIG. 2). The receiving member 2 is held in the standby position by the entry of the stopper 22 into the recessed part 30f.

In the illustrated example, the assisting means 4 are constituted by a tension coil spring 40 placed inside the lower chamber 31 of the main body 3. In the illustrated example, one spring end 40a of such spring 40 is fixed to one part 20c of the rear end of the base 20 of the receiving member 2 inserted into the lower chamber 31 through the slit 32 formed on the bottom part 30e of the upper chamber 30, and the other spring end 40b of such spring 40 is fixed to the side of the rear end of the lower chamber 31 of the main body 3, so that such spring 40 is most stretched when the receiving member 2 is in the standby position (FIG. 1).

In the illustrated example, the damping means 5 has a piston damper, which comprises a cylinder 50, a piston not illustrated, and a piston rod 51, so that damping force is applied to the movement or relative movement of the piston. In the illustrated example, such piston damper is placed between the receiving member 2 in the upper chamber 30 of the case and a rear end 30d of the upper chamber 30, in a manner such that the projecting end of the piston rod 51 is fixed to the base 20 of the receiving member 2 with the side of the piston rod 51 as the front side and retraction of the cylinder 50 is prevented. Also, the piston rod 51 is most projected from the inside of the cylinder 50 when the receiving member 2 is in the standby position (FIG. 1).

When the sliding door Ma as the movable body M is moved forward, the contact body 1 enters inside the main body 3 from the front end of the sliding door Ma at mid-course, passes between the projecting parts 21b of the pair of gripping pieces 21b, 21b of the receiving member 2 in the standby position, and collides with the front end face 21i of the main body part 21h of the slider 21 (FIG. 4). The slider 21 having collided with the contact body 1 retracts in opposition to the urging of the spring 23, and upon this retraction, the pair of gripping pieces 21b, 21b is positioned in the closed state (gripping state), in which the back part is allowed to slip out from the window part of the main body 3 and the contact body 1 is not allowed to slip out forward of the wall part 30b of the main body 3 (toward the side of the front end Md of the sliding door Ma) from between the projecting parts 21f, and the contact body 1 is caught by the receiving member 2. Also, when the slider 21 retracts in this manner, the stopper 22 is withdrawn into the base 20 and the holding of the receiving member 2 is released (FIG. 4). By this, the receiving member 2 is moved relatively toward the direction moving away from the front end Md of the sliding door Ma by the urging of the spring 40, and the contact body 1 provided on the stationary body S is caught by this receiving member 2. The sliding door Ma is therefore moved forward automatically up to the position where the front end Md is brought into collision with the doorstop part Sc (FIGS. 5 to 7). When the sliding door Ma is moved in return from this state, the receiving member 2 is moved relatively inside the main body 3 toward the direction opposite that during forward movement of the sliding door Ma, and upon reaching the standby position, the stopper 22 again enters into the recessed part 30f and advance of the slider 21 by the spring 23 is allowed, and the back parts of the gripping pieces 21b again enter into the window hole 30c and the pair of gripping pieces 21b, 21b become in an open state (non-gripping state), whereby release of the contact body 1 is accomplished (FIG. 3)

Also, the forward-moving mechanism according to this embodiment has means for preventing deformation 6 of the wall part 30b of the main body 3.

The movement of the receiving member 2 for receiving the contact body 1, after contacting with the contact body 1, is guided by the wall part 30b of such main body 3. Here, the movement of the receiving member 2 would be impeded if the wall part 30b of the main body 3 were to be deformed for some reason. Because deformation of at least the wall part 30b in the area y for movement of the receiving member 2 in the main body 3 is prevented, the movement of the receiving member 2 can always be accomplished smoothly, and the forward movement of the movable body M toward the prescribed position can be made smooth.

Specifically, in the illustrated example, the gripping pieces 21b of the receiving member 2 are moved inside the main body 3 while catching the contact body 1, with the closed state being maintained by the wall parts 30b of the main body 3. Therefore, the contact body 1 may slip out from between the pair of gripping pieces 21b if deformation widening the space between the left and right wall parts 30b, 30b of the main body 3 occurs. Also, conversely, the friction between the main body 3 and the receiving member 2 will become greater and movement of the receiving member 2 may be impeded if deformation narrowing the space between the left and right wall parts 30b, 30b of the main body 3 occurs. Such inconveniences can be prevented by providing means for preventing deformation 6 on the main body 3. More specifically, in the case when the main body 3 is constituted by a synthetic resin and is placed in the recessed area Me formed on the sliding door Ma, or the like, as the movable body M, made of a woody material, and when means for preventing deformation 6 are not provided, the space between the left and right wall parts 30b, 30b of the main body 3 may be narrowed if deformation in the direction of narrowing the recessed area Me occurs on the side of the sliding door Ma. Also, there is a possibility that deformation toward the direction of widening the space between the left and right wall parts 30b, 30b may be caused to the main body 3, in the case when there is an allowance between the outer surface of the main body 3 and the recessed area Me of the sliding door Ma or deformation toward the direction of widening the recessed area Me is caused by deformation on the side of the sliding door Ma. The space between the left and right wall parts 30b, 30b of the main body 3 can be kept constant even at such times by providing the means for preventing deformation 6 on the main body 3.

In the example illustrated in FIGS. 1 to 12, the main body 3 is constituted by a synthetic resin and such means for preventing deformation 6 are constituted by a metal material. The means for preventing deformation 6 are fitted from outside into of the receiving member 2 in the main body 3. Specifically, such means for preventing deformation 6 comprise a bottom board 60 and a pair of upright side boards 61, 61, having a length about equal to the area y for movement, and are constituted so as to accommodate the area y for movement of the main body 3 from above between the pair of upright side boards 61, 61. The space between the pair of upright side boards 61, 61 is about equal to the space on the outer-surface sides of the left and right wall parts 30b, 30b of the main body 3, and the measurement from a base part 61b to a top end of the upright side board 61 is about equal to the vertical measurement of the area y for movement of the main body 3. Also, an outwardly bent part 61a is formed across the entire length on the top ends of the pair of upright side boards 61, 61, and this bent part 61a is hung on the edge of the opening of the recessed area Me of the sliding door Ma (FIG. 3). Deformation such as to change the space between the upright side boards 61 constituting the means for preventing deformation 6 is thereby less likely to occur. That is, in this example, the means for preventing deformation 6 are provided with a reinforcing part. Also, in this example, the main body 3 and the means for preventing deformation 6 are respectively provided with a pair of latch parts 31b, 62. Specifically, in this example, a claw-form latch part 62 is formed respectively on the pair of upright side boards 61, 61 constituting the means for preventing deformation 6, by cutting off a portion divided by a pair of first cut-ins 62a, 62a continuing from a position at about the center in the vertical direction of the upright side boards 61 to the base part 61b and furthermore reaching apart of the bottom board 60 from this base part 61b and by a second cut-in 62b spanning between the end parts of the pair of first cut-ins 62a, 62a on the side of the bottom board 60, cutting downward from a position at about the center in the length direction of the first cut-in 62a, and by bending the remaining part inward with the upper-end position of the first cut-in 62a as the center of bending (FIG. 11). Also, a shallow pit 31a for placing the latch part 62 is formed respectively on the left and right outsides of the lower chamber 31 of the main body 3, in a place where the latch part 62 of the means for preventing deformation 6 is positioned when fitting the area y for movement of the main body 3 in the means for preventing deformation 6, and a bump-form latch part 31b is provided inside this pit 31a. The latch part 31b of the main body 3 has a guide surface 31d that gradually rises going toward a top part 31c downward from the top part 31c, and as the main body 3 is fitted into the means for preventing deformation 6, the claw-form latch part 62 is once bent slightly outward by the guide surface 31d, then the front end rides over the top part 31c at the end position of such fitting, the claw-form latch part 62 bends back, and is latched on the latch part 31b of the main body 3. In this example, such claw-form latch part 62 is provided toward the front side of the main body 3 on one of the pair of upright side boards 61, 61, and is provided further back from this on the other of the pair of upright side boards 61, 61. That is, in this example, the means for preventing deformation 6 are provided on the outside of the wall part 30b of the main body 3 and adjacent to this wall part 30b.

FIG. 13 illustrates an example in which an inwardly bent part 61a is furnished across the entire length on the top end of the upright side board 61 constituting the means for preventing deformation 6 according to the example illustrated in FIGS. 1 to 12, and a part for reinforcing the means for preventing deformation 6 is provided by this bent part 61a.

Also, FIG. 14 illustrates an example in which an inwardly bent part 61a is furnished only toward the rear not to impede the movement of the receiving member 2 and the contact body 1, respectively on the top ends of the pair of upright side boards 61, 61 constituting means for preventing deformation 6 according to the example illustrated in FIGS. 1 to 12, and the bent part 61a on the left side and the bent part 61a on the right side abut against each other in a position at about the center in the width direction of the main body 3.

Also, the means for preventing deformation 6 may be provided on the wall part 30b of the main body 3 in the area y for movement of the receiving member 2 (the area shaded with double-dotted lines in FIG. 15). Specifically, when forming the main body 3 with a synthetic resin, the means for preventing deformation 6 can be provided inside such wall part 30b, using a metal plate, not illustrated, having a size sufficient to cover the wall part 30b, by insertion molding or two-color molding the main body 3 in a manner such that the metal plate is embedded inside the wall part 30b.

Also, the means for preventing deformation 6 can be constituted by the wall part 30b of the main body 3 in the area y for movement of the receiving member 2 (the area shaded with double-dotted lines in FIG. 15), this wall part 30b in the area y for movement being constituted by a material having higher rigidity than the constituent material of another area of the main body 3.

Also, FIG. 16 illustrates an example in which a latch part 63 for latching to the recessed area Me is provided respectively on the pair of upright side boards 61, 61, constituting the means for preventing deformation 6 according to the example illustrated in FIGS. 1 to 12. In this example, the latch part 63 for latching to the recessed area Me is formed toward the front side on the upright side board 61 (the upright side board 61 on the right side in FIG. 16) where the claw-form latch part 62 is formed toward the rear, and toward the rear side on the upright side board 61 (the upright side board 61 on the left side in FIG. 16) where the claw-form latch part 62 is formed toward the front. In the illustrated example, the latch part 63 for latching to the recessed area Me is formed by bending a portion divided by a pair of first cut-ins 63a, 63a continuing a length in the vertical direction and by a second cut-in 63b spanning between the upper ends of the pair of first cut-ins 63a, 63a, bending outward with the lower-end position of the first cut-in 63a as the center of bending. In this example, the means for preventing deformation 6 can be installed in the recessed area Me with one touch, by fitting the means for preventing deformation 6 into the recessed area Me, bringing these latch parts 31b, 62 into collision with the inner surface of the recessed area Me. By this, in this example, the main body 3 can be set in the recessed area Me using the latch parts 63 for latching to the recessed area Me, by fitting the main body 3, integrated with the means for preventing deformation 6 by the pair of latch parts 31b, 62, into the recessed area Me, and the main body 3 also can be set in the recessed area Me, by first installing the means for preventing deformation 6 into the recessed area Me and then fitting the main body 3 into the means for preventing deformation 6.

The entire contents of the specification, claims, drawings, and abstract of Japanese Patent Application No. 2008-283226, filed on Nov. 4, 2008, are incorporated by reference herein as a disclosure of the specification of the present invention.

What is claimed is:

1. A forward-moving mechanism of a movable body, comprising:
a receiving member placed movably inside a main body placed in a recessed area provided on either one of a movable body or a stationary body supporting the movable body to be capable of reciprocal movement, and linking to a damping device for applying a damping force to forward movement of the movable body toward a prescribed position, an assisting device for enabling the movable body to move forward up to the prescribed position, or the damping device and the assisting device; and
a contact body provided on the other of the movable body and the stationary body contacting with the receiving member and moving inside the main body in the process of forward movement of the movable body;
wherein at least a movable area of the receiving member in the main body is open at a releasing side of the recessed area and includes a wall part for guiding the movement of the receiving member; and
a device for preventing deformation of the wall part is provided adjacent to the wall part, or inside the wall part.

2. A forward-moving mechanism of a movable body, comprising:
a receiving member placed movably inside a main body placed in a recessed area provided on either one of a movable body or a stationary body supporting the movable body to be capable of reciprocal movement, and linking to a damping device for applying a damping force to forward movement of the movable body toward a prescribed position, an assisting device for enabling the movable body to move forward up to the prescribed position, or the damping device and the assisting device; and
a contact body provided on the other of the movable body and the stationary body contacting with the receiving member and moving inside the main body in a process of the forward movement of the movable body;
wherein at least a movable area of the receiving member in the main body is open at a releasing side of the recessed area and includes a wall part for guiding the movement of the receiving member; and
the wall part is formed by a material having higher rigidity than a composing material of another part of the main body.

3. A forward-moving mechanism of a movable body according to claim 1 or 2, wherein the receiving member comprises a catcher for catching the contact body.

4. A forward-moving mechanism of a movable body according to claim 3, wherein the catcher comprises a gripping piece for gripping and catching the contact part, and the state of gripping of the gripping piece is maintained by the wall part of the main body.

5. A forward-moving mechanism of a movable body according to claim 1, 3 or 4, wherein the device for preventing deformation are formed by a metal material.

6. A forward-moving mechanism of a movable body according to claim 1, 3, 4 or 5, wherein the device for preventing deformation comprises a reinforcing part.

7. A forward-moving mechanism of a movable body according to claim 1, 3, 4, 5 or 6, wherein a pair of latch parts is provided respectively on the main body and the device for preventing deformation.

8. A forward-moving mechanism of a movable body according to claim 1, 3, 4, 5, 6 or 7, wherein the device for preventing deformation is provided with a latch part for latching with the recessed area.

9. A forward-moving mechanism of a movable body according to claim 1, wherein the main body and the device for preventing deformation are constructed separably, the device for preventing deformation is provided with a latch part for latching with the recessed area, and a pair of latch parts is provided respectively on the main body and the device for preventing deformation.
